(19) United States
(12) Patent Application Publication
(10) Pub. No.: US 2005/0152402 A1
(43) Pub. Date: Jul. 14, 2005

(54) Signal processing device for collating bit, signal processing method, and signal processing program

(75) Inventor: Masahiro Umewaka, Ota (JP)

Correspondence Address: OSHA LIANG L.L.P., 1221 MCKINNEY STREET, SUITE 2800, HOUSTON, TX, 77010, US

(73) Assignee: Sanyo Electric Co., Ltd., Osaka (JP)

(21) Appl. No.: 11/029,864

(22) Filed: Jan. 5, 2005

(30) Foreign Application Priority Data
Jan. 9, 2004 (JP) JP2004-004315

(51) Int. Cl. H04J 3/24; H04L 12/50; H04Q 11/00

(52) U.S. Cl. 370/474; 370/311

(57) ABSTRACT

There is disclosed a signal processing device including a reception part which receives a signal from outside, a preliminary detection part, a main processing part whose power consumption is larger than that of the preliminary detection part, and a power supply part which supplies power to the main processing part. The preliminary detection part collates bit values of bit information constituted of a combination of bit values included in the signal received by the reception part and those of collation key information constituted of a combination of preset bit values. Moreover, the power is supplied to the main processing part from the power supply part in a case where all the bit values agree with each other.

### CROSS-REFERENCE TO RELATED APPLICATION

The entire disclosure of Japanese Application No. 2004-4315 including specification, claims, drawings, and abstract is incorporated herein by reference.

### BACKGROUND OF THE INVENTION

1. Field of the Invention

The present invention relates to a signal processing device, a signal processing method and a signal processing program, having a function of collating bit information included in a transmitted signal.

2. Description of the Related Art

A keyless entry technique has been broadly used to remotely unlock an automobile door using a signal of an infrared ray or the like without using a conventional cylinder key. In this keyless entry technique, a key registers collation key information represented by a predetermined bit stringbeforehand, receives a signal transmitted from an automobile, and judges whether or not bit information included in the signal agrees with the collation key information to thereby control the unlocking of the door.

FIG. 8 shows a signal processing device 100 disposed in a key. The signal processing device 100 comprises a reception part 10, a preliminary detection part 12, a main processing part 14, a power supply control part 16, a power supply part 18, and a transmission part 20. Usually, in order to suppress the power consumption, no power is supplied from the power supply part 18 to the main processing part 14 whose power consumption is large, and the power is supplied to the preliminary detection part 12 whose power consumption is small in a standby state.

As shown in FIG. 9, a preliminary signal indicating that a signal is starting, and a subsequent vehicle transmission signal including the bit information are repeatedly transmitted from the automobile. The reception part 10 receives the vehicle transmission signal from the outside of the device, rectifies and detects the signal, and thereafter transmits the signal to the preliminary detection part 12 and the main processing part 14. The preliminary detection part 12 receives the signal from the reception part 10, and judges whether or not a pulse amplitude is not less than a predetermined threshold value α. When an intensity of the vehicle transmission signal is larger than the threshold value α, it is assumed that the preliminary signal has been received, and a power supply start signal is sent to the power supply control part 16. On receiving the supply start signal, the power supply control part 16 starts the supply of the power to the main processing part 14 from the power supply part 18. Accordingly, the main processing part 14 is brought into an on-state, and the bit information following the preliminary signal is received from the reception part 10 to thereby collate the information with the collation key information registered beforehand. When the bit information included in the vehicle transmission signal agrees with the bit information of the collation key information, a response signal is transmitted from the transmission part 20. When this response signal is received on the automobile side, the door is unlocked.

It is to be noted that a technique to collate the vehicle transmission signal with a collation key has been described in Japanese Patent Application Laid-Open Nos. Hei 8-62327 and Hei 8-62328.

However, in the above-described conventional technique, it is judged whether or not the received signal is a signal transmitted from the automobile depending on whether the amplitude of the preliminary signal is not less than the predetermined threshold value α. Therefore, when noise having an intensity not less than the threshold value α is received, it is judged by mistake that the signal transmitted from the automobile has been input, the supply of the power to the main processing part 14 is started, and a problem that the power consumption in the signal processing device 100 increases has occurred.

### SUMMARY OF THE INVENTION

According to the present invention, there is provided a signal processing device including a reception part which receives a signal from the outside, a preliminary detection part, a main processing part whose power consumption is larger than that of the preliminary detection part, and a power supply part which supplies power to the main processing part, wherein the preliminary detection part collates bit values of bit information constituted of a combination of bit values included in the signal received by the reception part and those of collation key information constituted of a combination of preset bit values, to supply the power from the power supply part to the main processing part only in a case where at least some bit values agree with each other.

According to another configuration of the present invention, there is provided a signal processing method executed in a signal processing device including, a reception part which receives a signal from the outside, a preliminary detection part, a main processing part whose power consumption is larger than that of the preliminary detection part, and a power supply part which supplies power to the main processing part, the method comprising a receiving step of receiving the signal from the outside using the reception part, a preliminary detecting step of collating bit values of bit information constituted of a combination of bit values received in the receiving step and those of collation key information constituted of a combination of preset bit values using the preliminary detection part, and a power supplying step of supplying the power to the main processing part from the power supply part only in a case where at least some bit values of the bit information agree with those of the collation key information in the preliminary detection step.

According to still another configuration of the present invention, there is provided a signal processing program in a signal processing device including a computer, a reception part which receives a signal from the outside, a main processing part whose power consumption is larger than that of the computer, and a power supply part which supplies power to the main processing part, the program allowing the computer to function as preliminary detection means for collating bit values of bit information constituted of a combination of bit values included in the signal received by the reception part and those of collation key information constituted of a combination of preset bit values, and supplying the power to the main processing part from the power supply part only in a case where at least some bit values agree with each other.

### BRIEF DESCRIPTION OF THE DRAWINGS

FIG. 1 is a block diagram showing a constitution of a signal processing device in an embodiment of the present invention;

FIG. 2 is a timing chart showing a function of the signal processing device in the embodiment of the present invention;

FIG. 3 is a diagram showing an example of a circuit of a boundary detection part in the embodiment of the present invention;

FIG. 4 is a timing chart showing production of a boundary signal by the boundary detection part in the embodiment of the present invention;

FIG. 5 is a diagram showing an example of a circuit of an excess period signal production part in the embodiment of the present invention;

FIG. 6 is a diagram showing an example of a circuit of a shift signal production part in the embodiment of the present invention;

FIG. 7 is a diagram showing an example of a circuit of a demodulated data acquisition part and a bit comparison part in the embodiment of the present invention;

FIG. 8 is a block diagram showing a constitution of a signal processing device in a background technique; and

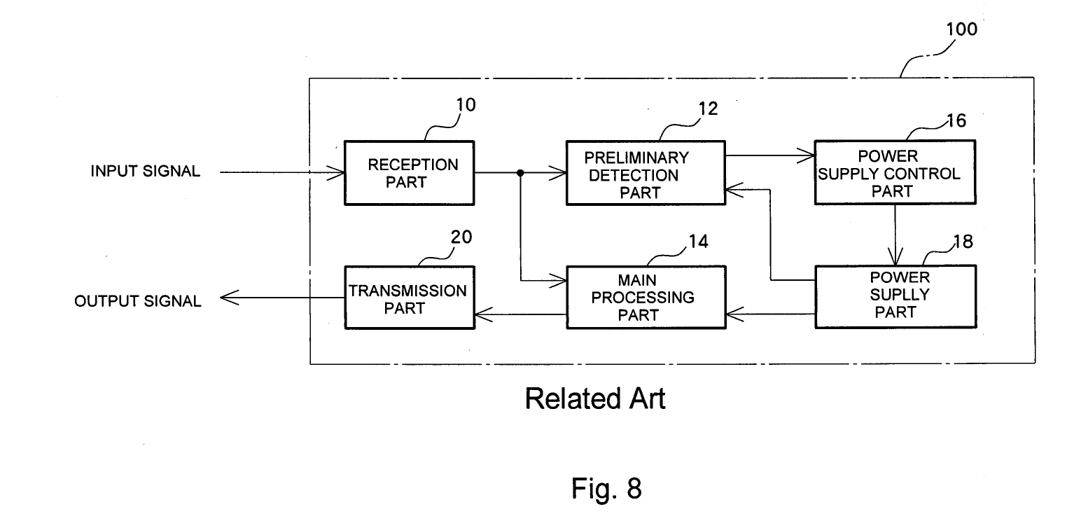

FIG. 9 is a diagram showing an example of a demodulated pulse signal including bit information in the background technique.

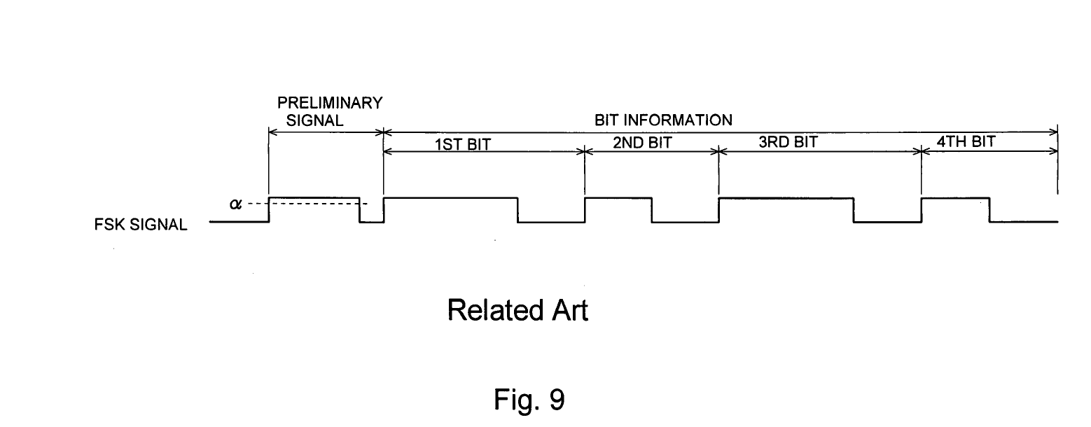

### DESCRIPTION OF THE PREFERRED EMBODIMENTS

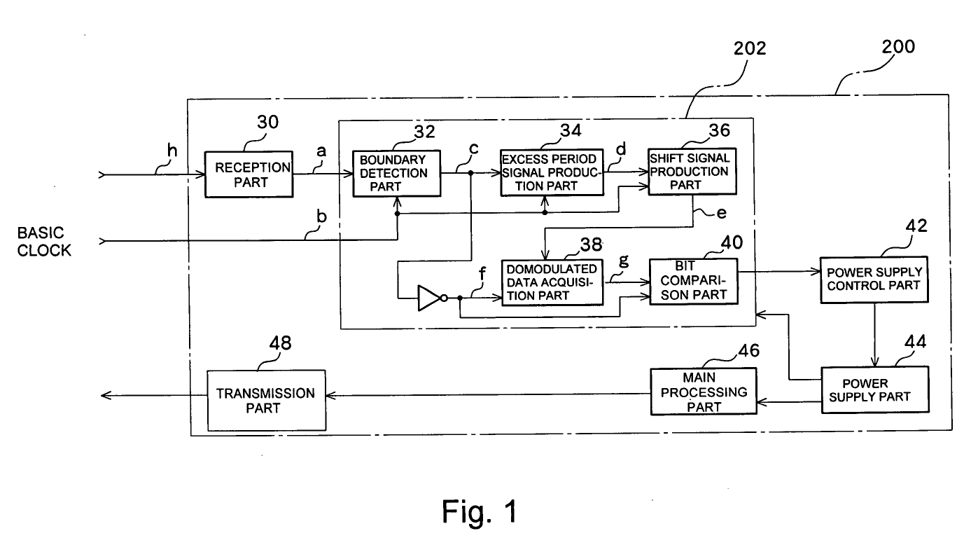

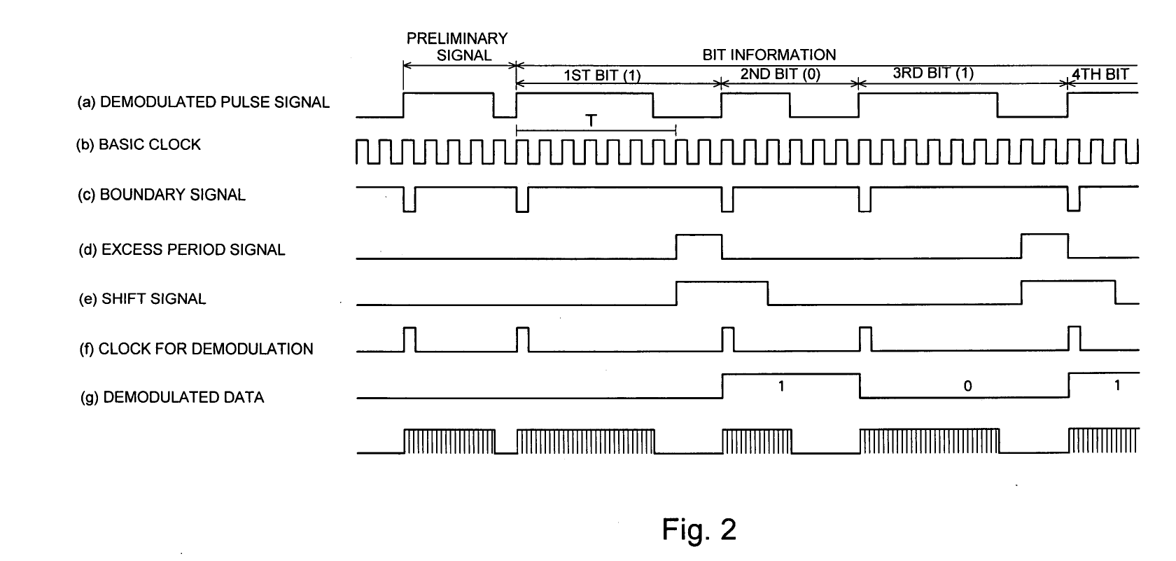

As shown in FIG. 1, a signal processing device 200 in an embodiment of the present invention comprises a reception part 30, a boundary detection part 32, an excess period signal production part 34, a shift signal production part 36, a demodulated data acquisition part 38, a bit comparison part 40, a power supply control part 42, a power supply part 44, a main processing part 46, and a transmission part 48. The boundary detection part 32, excess period signal production part 34, shift signal production part 36, demodulated data acquisition part 38, and bit comparison part 40 constitute a preliminary detection unit 202 of the present embodiment. A function of the signal processing device 200 in the present embodiment will be described hereinafter with reference to a timing chart of FIG. 2.

As shown in FIG. 2(h), an ASK signal superimposed on a carrier wave of hundred several ten kHz is transmitted from an object to be unlocked, such as an automobile. The reception part 30 receives this ASK signal, adjusts a signal level by auto gain control (AGC), and thereafter demodulates the signal into a demodulated pulse signal shown in FIG. 2(a) using a detector circuit. The reception part 30 transmits the demodulated pulse signal to the boundary detection part 32.

The demodulated pulse signal includes a preliminary signal indicating the start of the signal, and subsequent signals indicating bit information. The bit information is preferably frequency modulated. For example, it is assumed that to be capable of understanding the relation of FIGS. 2(a) and (b), the bit information indicates “1 (H level)” in a case where a pulse period is longer than a time T for seven periods of a base clock, and indicates “0 (L level)” in a case where the pulse period is shorter than the time T for seven periods of the base clock. Additionally, the relation between the period of the pulse of the demodulated pulse signal and the period of the base clock is not limited to this relation, and may be such a relation that the bit information of the demodulated pulse signal can be judged.

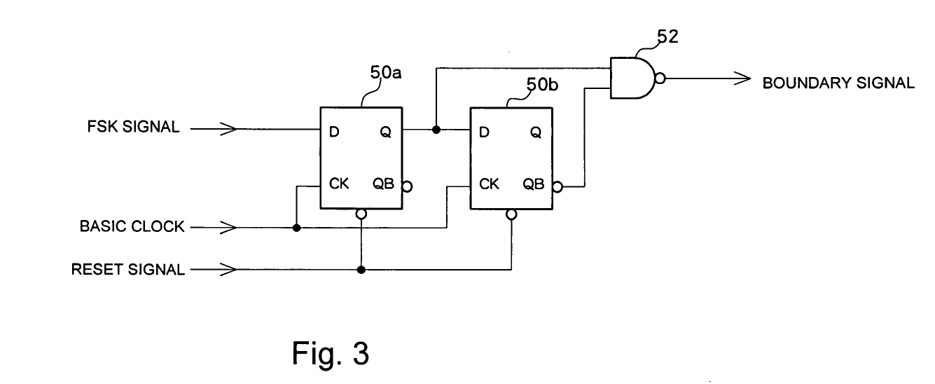

The boundary detection part 32 has a function of detecting a boundary at which the demodulated pulse signal rises from “L level” to “H level”. As shown in FIG. 3, the boundary detection part 32 may comprise D flip flops (DFFs) 50a, 50b and a NAND element 52. The demodulated pulse signal is supplied to an input terminal (D terminal) of the DFF 50a from the reception part 30. The D terminal of the DFF 50b is connected to an output terminal (Q terminal) of the DFF 50a. Base clocks CK are input into clock terminals (CK terminals) of the DFFs 50a, 50b. Reset signals are input into reset terminals (R terminals) of the DFFs 50a, 50b. The reset signal is usually maintained at the “H level”, and set to the “L level” only in a case where the signal processing device 200 is brought back into an initial state. Outputs from the Q terminal of the DFF 50a and a reverse output terminal (QB terminal) of the DFF 50b are input into the NAND element 52.

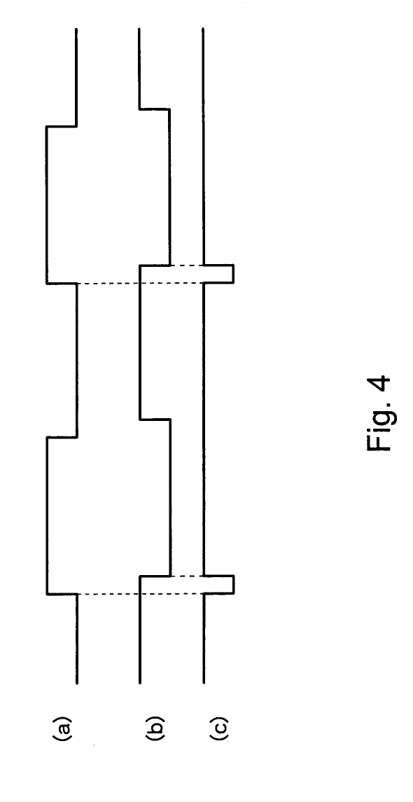

As shown in FIG. 4(a), after the demodulated pulse signal rises to the “H level” from the “L level”, and from when the base clock next turns to the “H level”, the “H level” continues to be output from the Q terminal of the DFF 50a. After the demodulated pulse signal turns to the “L level” from the “H level”, and the base clock next turns to the “H level”, the “L level” continues to be output. As shown in FIG. 4(b), a signal which changes in reverse to the output of the Q terminal of the DFF 50a is output from the QB terminal of the DFF 50b delayed by one period of the base clock after the output of the Q terminal of the DFF 50a changes. As a result, as shown in FIG. 4(c), after the demodulated pulse signal rises to the “H level” from the “L level”, and from when the base clock next turns to the “H level”, a pulsed boundary signal indicating the “L level” is output from the NAND element 52 until the base clock next turns to the “H level”. Therefore, the boundary signal with respect to the demodulated pulse signal shown in FIG. 2(a) is as shown in FIG. 2(c).

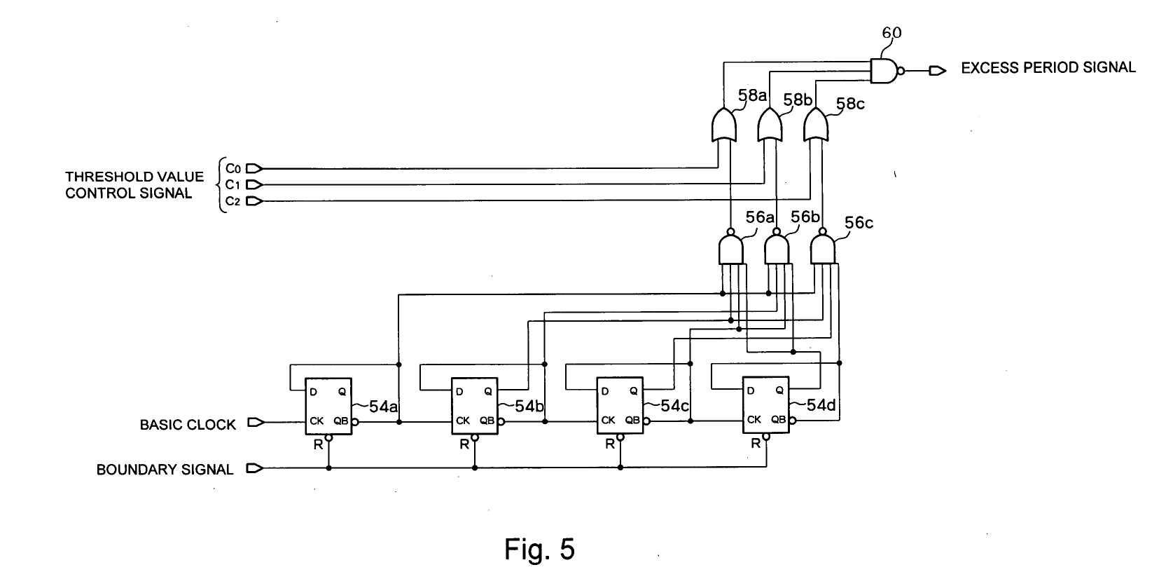

The excess period signal production part 34 has a function of producing an excess period signal indicating that the bit information included in the demodulated pulse signal is “1” or “0”. As shown in FIG. 5, the excess period signal production part 34 comprises D flip flops (DFFs) 54a, 54b, 54c, 54d, NAND elements 56a, 56b, 56c, OR elements 58a, 58b, 58c, and NAND element 60.

The boundary signals produced by the boundary detection part 32 are input into reset terminals (R terminals) of the DFFs 54a to 54d. A base clock is input into a clock terminal (CK terminal) of the DFF 54a. Output signals from a reverse output terminal (QB terminal) of the DFF 54a are input into a CK terminal of the DFF 54b, an input terminal (D terminal) of the DFF 54a, and the NAND elements 56a to 56c. Similarly, output signals from a QB terminal of the DFF 54b are input into a CK terminal of the DFF 54c, a D terminal of the DFF 54b, and the NAND element 56b. Output signals from an output terminal (Q terminal) of the DFF 54b are input into the NAND elements 56a, 56c. Output signals from a QB terminal of the DFF 54c are input into a CK terminal of the DFF 54d, a D terminal of the DFF 54c, and the NAND elements 56a, 56b. An output signal from a Q terminal of the DFF 54c is input into the NAND element 56c. Output signals from a QB terminal of the DFF 54d are input into a D terminal of the DFF 54d and the NAND element 56c. Output signals from a Q terminal of the DFF 54d are input into the NAND elements 56a, 56b.

Output signals of the NAND elements 56a, 56b, 56c are input into the OR elements 58a, 58b, 58c, respectively. Furthermore, threshold value control signals C₀, C₁, C₂ are input into the OR elements 58a, 58b, 58c. Output signals of the OR elements 58a, 58b, 58c are input into the NAND element 60.

The threshold value control signals C₀, C₁, C₂ are set as three-bit binary values, and a magnification of the period of the pulse included in the demodulated pulse signal with respect to the period of the base clock, at which it is judged that the bit value is “1”, is determined by this binary value. For example, when “1”, “0”, “1” are set to C₀, C₁, C₂, as shown in FIG. 2(d), the excess period signal indicates the “H level” in a case where the period of the pulse included in the demodulated pulse signal is the “H level” for a period seven or more times that of the base clock.

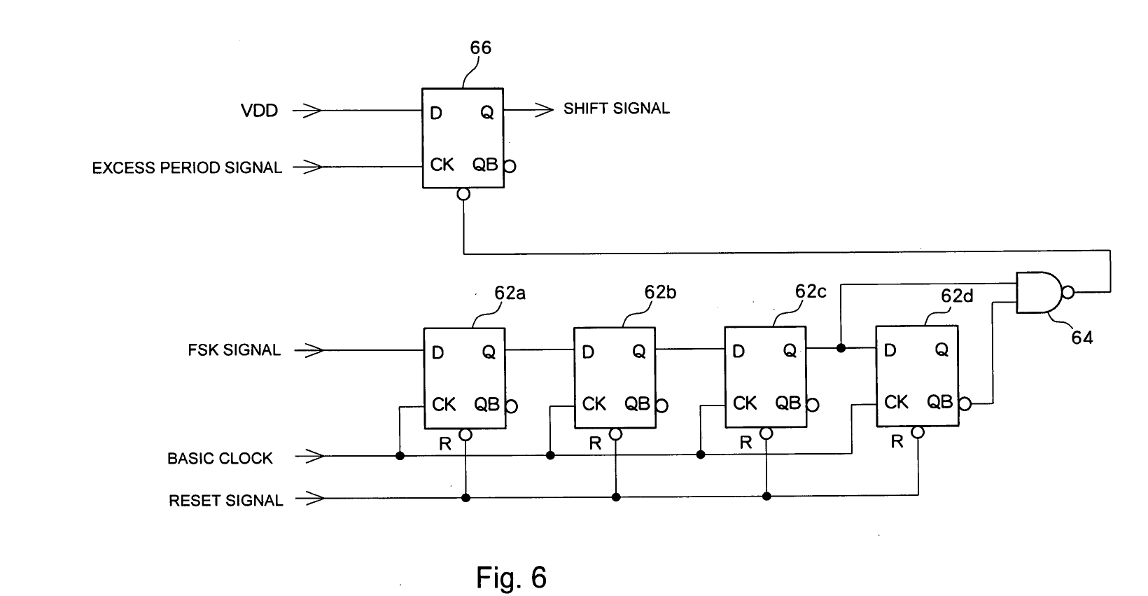

The shift signal production part 36 has a function of expanding a pulse width of the excess period signal output from the excess period signal production part 34. As shown in FIG. 6, the shift signal production part 36 comprises D flip flops (DFFs) 62a, 62b, 62c, 62d, a NAND element 64, and a D flip flop (DFF) 66. A demodulated pulse signal is input into an input terminal (D terminal) of the DFF 62a. Output signals from output terminals (Q terminals) of the DFFs 62a, 62b, 62c are input into D terminals of the DFFs 62b, 62c, 62d, respectively. Base clocks and reset signals are input into clock terminals (CK terminals) and reset terminals (R terminals) of the DFFs 62a to 62d. An output signal of the Q terminal of the DFF 62c is input into the NAND element 64. An output signal of a reverse output terminal (QB terminal) of the DFF 62d is input into the NAND element 64. An output signal of the NAND element 64 is input into an R terminal of the DFF 66. Furthermore, “H level” is constantly input into a D terminal of the DFF 66, and an excess period signal is input into a CK terminal thereof from the excess period signal production part 34. A shift signal is output to the demodulated data acquisition part 38 from a Q terminal of the DFF 66.

The DFFs 62a to 62d and the NAND element 64 are constituted in such a manner that the DFFs 62a, 62b are further added on an input side of the boundary detection part 32. Therefore, after elapse of a time for two periods of the base clock from when the boundary signal output from the boundary detection part 32 outputs a pulse of the “L level”, the signal outputs a pulse of “L level” to the R terminal of the DFF 66. That is, a state of the output signal of the Q terminal of the DFF 66 is changed delayed by two periods of the base clock from when the boundary signal is set to the “L level”. The D terminal of the DFF 66 is constantly maintained at the “H level”, and the excess period signal is input to the CK terminal thereof from the excess period signal production part 34. Therefore, as shown in FIG. 2(e), the shift signal output from the Q terminal turns to the “H level”, when the excess period signal turns to the “H level”, and maintains the “H level” from when the boundary signal is set to the “L level” until a time for two periods of the base clock elapses.

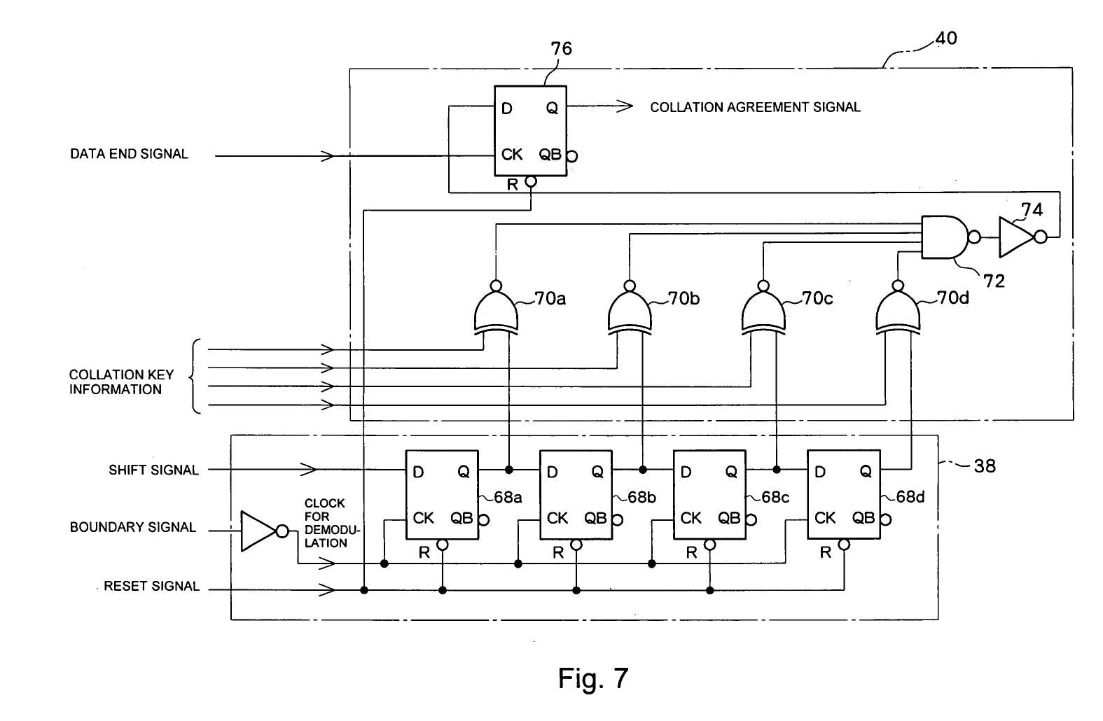

The demodulated data acquisition part 38 receives the shift signal from the shift signal production part 36, and demodulates and maintains the bit information included in the demodulated pulse signal. When the bit information included in the demodulated pulse signal is represented by four bits, as shown in FIG. 7, the demodulated data acquisition part 38 may comprise D flip flops (DFFs) 68a, 68b, 68c, 68d. The shift signal is input into an input terminal (D terminal) of the DFF 68a. Output signals from output terminals (Q terminals) of the DFFs 68a to 68c are input into D terminals of the DFFs 68b to 68d, respectively. Clocks for demodulation, obtained by reversing the boundary signals, are input into clock terminals (CK terminals) of the DFFs 68a to 68d, and reset signals are input into reset terminals (R terminals) thereof.

Every time the boundary signal turns to the “H level”, the demodulated data acquisition part 38 shift output values of the Q terminals of the DFFs 68a to 68c to the DFFs 68b to 68d, respectively, and holds a state of the shift signal input into the D terminal of the DFF 68a as an output value of the Q terminal of the DFF 68a. That is, as shown in FIG. 2(f), the bit information of four bits included in the demodulated pulse signal is demodulated by the demodulated data acquisition part 38, and lower to upper bits are held in order as the output signals of the Q terminals of the DFFs 68a to 68d.

The bit comparison part 40 has a function of outputting a collation agreement signal in a case where the bit information demodulated by the demodulated data acquisition part 38 is collated with the collation key information, and all bit values of the bit information included in the demodulated pulse signal agree with those of the collation key information. As shown in FIG. 7, the bit comparison part 40 may comprise XNOR elements 70a, 70b, 70c, 70d, a NAND element 72, a NOT element 74, and a D flip flop (DFF) 76.

The output signal of the Q terminal of the DFF 68a in the demodulated data acquisition part 38, and the lowermost bit value of the collation key information are input into the XNOR element 70a. Therefore, when the output signal of the Q terminal of the DFF 68a agrees with the lowermost bit value of the collation key information, the “H level” is output to an output terminal of the XNOR element 70a. When the signal does not agree, the “L level” is output. Similarly, the output signals of the Q terminals of the DFFs 68b, 68c, 68d in the demodulated data acquisition part 38, and the second and the third bit values from the lowermost bit and the uppermost bit value of the collation key information are input into the XNOR elements 70b, 70c, 70d. In the case of agreement of the input signals of the XNOR elements 70b, 70c, 70d, the “H level” is output to the output terminal. When the signals do not agree, the “L level” is output.

The output signals of the XNOR elements 70a to 70d are input into the NAND element 72. When all the input signals of the NAND element 72 turn to the “H level”, the “L level” is output to the output terminal. In another case, the “H level” is output to the output terminal. That is, the “L level” is output to the output terminal of the NAND element 72 only in a case where all the bit values of the bit information detected from the demodulated pulse signal in the demodulated data acquisition part 38 agree with those of the collation key information. When even one bit value of the bit information detected from the demodulated pulse signal does not agree with that of the collation key information, the “H level” is output to the output terminal of the NAND element 72.

The output signal of the NAND element 72 is reversed by the NOT element 74, and input into an input terminal (D terminal) of the DFF 76. A data end signal indicating an end time of the demodulated pulse signal is input into a clock terminal (CK terminal) of the DFF 76. Therefore, when all the bit values of the bit information detected from the demodulated pulse signal agree with those of the collation key information, an output terminal (Q terminal) of the DFF 76 is maintained at the “H level”. When even one bit value of the bit information detected from the demodulated pulse signal does not agree with that of the collation key information, the Q terminal of the DFF 76 is maintained at the “L level”. The output signal of the Q terminal of the DFF 76 is input as the collation agreement signal into the power supply control part 42.

The power supply control part 42 receives the collation agreement signal, and starts the supply of the power to the main processing part 46 from the power supply part 44, when the collation agreement signal indicates the “H level”. On the other hand, when the collation agreement signal indicates the “L level”, no power is supplied to the main processing part 46. When the power is supplied, the main processing part 46 is brought into an on-state, and a process of transmitting a response signal from the transmission part 48 or the like is executed. When this response signal is received, a process of unlocking the door or the like is performed on the automobile side.

As described above, in the present embodiment, power is supplied to the main processing part 46 only in a case where all the bit values of the bit information included in the demodulated pulse signal agree with those of the collation key information. Therefore, when noise is received by the reception part 30, an erroneous operation of starting the supply of the power to the main processing part 46 can be inhibited. As a result, an increase of power consumption can be suppressed. The present invention is highly effective especially in a small-sized signal processing device requiring portability, such as a portable key driven by a small-capacity power supply such as a battery.

It is to be noted that the present invention is not limited to a concrete constitution in the above-described embodiment. That is, regardless of the unlocking process, the bit value of the bit information which has been transmitted from a process object and whose frequency has been modulated may be collated with that of the collation key information, and the supply of the power to a circuit having a larger power consumption may be started in accordance with the collation result. For example, when at least some bit values of the bit information of the demodulated pulse signal agree with those of the bit information of the collation key information, the power may be supplied to the main processing part.

1. A signal processing device including: a reception part which receives a signal from outside; a preliminary detection part; a main processing part whose power consumption is larger than that of the preliminary detection part; and a power supply part which supplies power to the main processing part,
wherein the preliminary detection part collates bit values of bit information constituted of a combination of bit values included in the signal received by the reception part and those of collation key information constituted of a combination of preset bit values, to supply the power from the power supply part to the main processing part only in a case where at least some bit values agree with each other.

2. The signal processing device according to claim 1, wherein the bit information is a signal whose frequency has been modulated in accordance with the bit value.

3. A signal processing method executed in a signal processing device including: a reception part which receives a signal from the outside; a preliminary detection part; a main processing part whose power consumption is larger than that of the preliminary detection part; and a power supply part which supplies power to the main processing part, the method comprising:
a receiving step of receiving the signal from outside by use of the reception part;
a preliminary detecting step of collating bit values of bit information constituted of a combination of bit values received in the receiving step and those of collation key information constituted of a combination of preset bit values by use of the preliminary detection part; and
a power supplying step of supplying power to the main processing part from the power supply part only in a case where at least some bit values of the bit information agree with those of the collation key information in the preliminary detecting step.

4. The signal processing method according to claim 3, wherein the signal including the bit information is a signal whose frequency has been modulated in accordance with the bit value.

5. A signal processing program in a signal processing device including:
a computer;
a reception part which receives a signal from outside;
a main processing part whose power consumption is larger than that of the computer; and
a power supply part which supplies power to the main processing part,
the program allowing the computer to function as preliminary detection means for collating bit values of bit information constituted of a combination of bit values included in the signal received by the reception part and those of collation key information constituted of a combination of preset bit values, and supplying the power to the main processing part from the power supply part only in a case where at least some bit values agree with each other.

6. The signal processing program according to claim 5, wherein the bit information is a signal whose frequency has been modulated in accordance with the bit value.
